(19) United States
(12) Patent Application Publication
(10) Pub. No.: US 2014/0368446 A1
(43) Pub. Date: Dec. 18, 2014

(54) IN-CELL TOUCH SCREEN AND APPARATUS OF DRIVING THE SAME

(71) Applicant: HIMAX TECHNOLOGIES LIMITED, Tainan City (TW)

(72) Inventors: YAW-GUANG CHANG, Tainan City (TW); Wei-Song Wang, Tainan City (TW)

(21) Appl. No.: 13/919,775

(22) Filed: Jun. 17, 2013

(51) Int. Cl. G06F 3/041

(52) U.S. Cl. CPC G06F 3/0412
USPC 345/173

(57) ABSTRACT

An apparatus of driving an in-cell touch screen, a transmitter (TX) driving unit generates TX driving signals coupled to a common-voltage electrode substrate, and RX detection signals are then induced on an RX electrode substrate that is coupled to and detected by an RX detection unit. The voltage swing of the TX driving signal is determined according to current leakage in thin film transistor (TFT) unit cells of a liquid crystal module (LCM).

### BACKGROUND OF THE INVENTION

1. Field of the Invention

The present invention generally relates to an in-cell touch screen, and more particularly to apparatus of driving an in-cell touch screen.

2. Description of Related Art

A touch screen is an input/output device that combines touch technology and display technology to enable users to directly interact with what is displayed. A variety of touch screen architectures have been proposed and manufactured. In order to make the touch screen thinner (and lighter), some in-cell touch screen architectures are proposed to relocate sensing electrode layers into a liquid crystal module (LCM) of the touch screen, instead of stacking the sensing electrode layers on the LCM.

One disadvantage of the in-cell touch screen is its lower touch sensitivity (or lower signal-to-noise ratio) than other types of touch screen. Although some schemes of increasing touch sensitivity have been proposed, most schemes, however, have adverse effects, e.g., lower display quality, on the touch screen.

For the foregoing reasons, a need has thus arisen to propose a novel scheme to increase touch sensitivity without adverse effects.

### SUMMARY OF THE INVENTION

In view of the foregoing, it is an object of the embodiment of the present invention to provide apparatus of driving an in-cell touch screen to substantially raise a voltage swing of a transmitter (TX) driving signal, therefore substantially enhancing touch sensitivity without affecting display quality of the in-cell touch screen.

According to one embodiment, an in-cell touch screen includes a common-voltage electrode substrate, a transmitter (TX) driving unit, a receiver (RX) electrode substrate and an RX detection unit. The TX driving unit is configured to generate TX driving signals coupled to the common-voltage electrode substrate associated with a liquid crystal module (LCM). RX detection signals are then induced on the RX electrode substrate due to the TX driving signals. The RX detection unit is configured to detect the RX detection signals. The voltage swing of the TX driving signal is determined according to current leakage in thin film transistor (TFT) unit cells of the LCM. In one embodiment, the voltage swing of the TX driving signal is a sum of magnitude of a common voltage associated with the common-voltage electrode substrate, and magnitude of an extended negative voltage.

### BRIEF DESCRIPTION OF THE DRAWINGS

FIG. 1 shows a schematic diagram illustrating apparatus of driving an in-cell touch screen according to one embodiment of the present invention;

FIG. 2A schematically shows a TFT unit cell;

FIG. 2B and FIG. 3 show exemplary drain-to-source current Ids with respect to gate-to-source voltage Vgs;

FIG. 4 shows an exemplary waveform of a TX driving signal; and

FIG. 5 schematically shows a circuit of generating a TX driving signal.

### DETAILED DESCRIPTION OF THE INVENTION

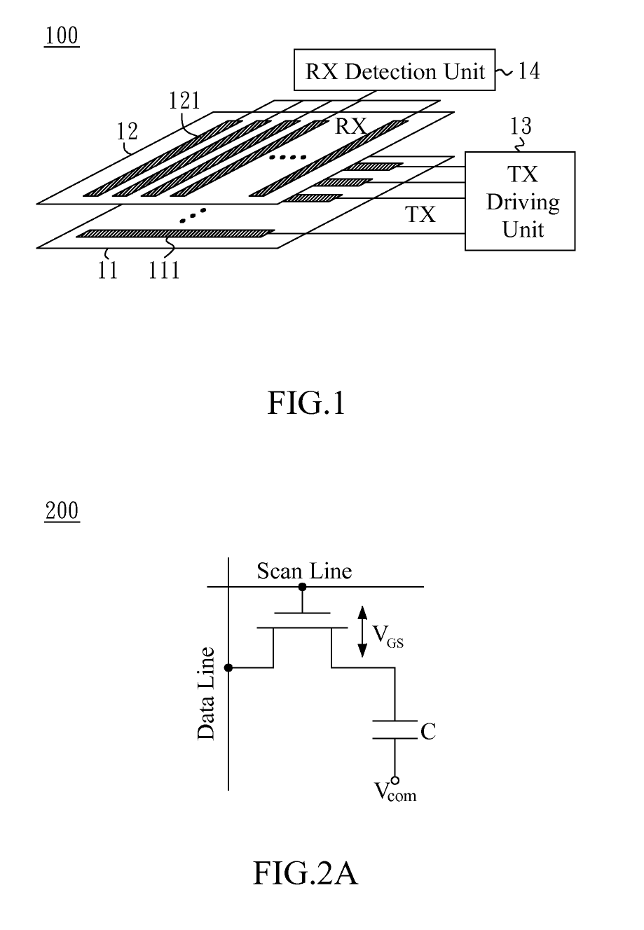

FIG. 1 shows a schematic diagram illustrating apparatus of driving an in-cell touch screen 100 according to one embodiment of the present invention. In the specification, an in-cell touch screen is an electronic visual display with sensing electrode layers disposed within a liquid crystal module (LCM). For better understanding the embodiment, only touch portion of the in-cell touch screen 100 is shown in FIG. 1. According to one aspect of the embodiment, a common-voltage electrode substrate of the LCM is utilized as a transmitter (TX) electrode substrate 11, which is patterned with a plurality of TX electrode lines 111 that are disposed substantially parallel to each other. Although line-shaped TX electrode lines 111 are exemplified in FIG. 1, the TX electrode lines 111 may have other shape such as rhombus. The embodiment also includes a receiver (RX) electrode substrate 12 patterned with a plurality of RX electrode lines 121 that are disposed substantially parallel to each other. Although line-shaped RX electrode lines 121 are exemplified in FIG. 1, the RX electrode lines 121 may have other shape such as rhombus. The TX electrode lines 111 may, but not necessarily, be substantially perpendicular to the RX electrode lines 121.

As shown in FIG. 1, the TX electrode lines 111 are coupled to respectively receive TX driving signals from a TX driving unit 13. An RX detection unit 14 is coupled to receive RX detection signals from the RX electrode lines 121, respectively. The RX detection signals are induced by capacitances between the TX electrode lines 111 and the RX electrode lines 121, and the capacitances may be affected, for example, by a finger touched above the RX electrode substrate 12. Therefore, the induced RX detection signal with affected capacitance may then be used, in companion with the driven TX electrode line, to determine the touched position.

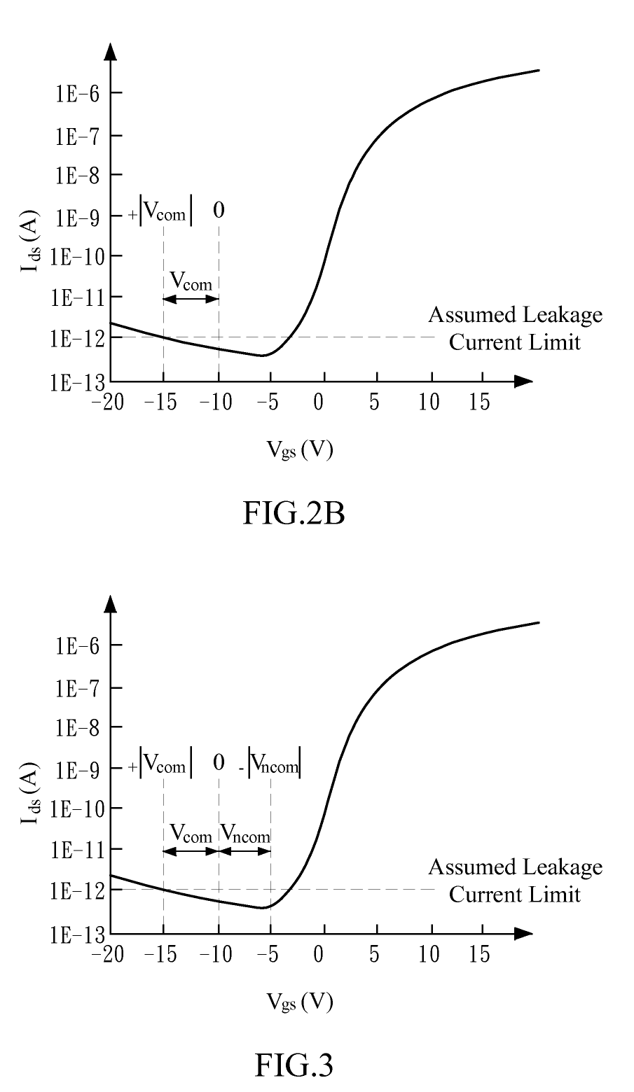

According to another aspect of the embodiment, a voltage swing of the TX driving signal is raised without worsening current leakage in thin film transistor (TFT) unit cells in the display portion of the in-cell touch screen 100. FIG. 2A schematically shows a TFT unit cell 200 with a gate coupled to a scan line, a drain coupled to a data line, and a source coupled, via a capacitor C, to a common voltage Vcom. FIG. 2B shows exemplary drain-to-source current Ids with respect to gate-to-source voltage Vgs. Further superimposed on FIG. 2 is the common voltage Vcom. It is worth noting that, if the voltage swing of Vcom is increased (that is, moved leftward in the figure) in order to enhance touch sensitivity of a touch screen (particularly an in-cell touch screen), leakage current will be increased, thereby reducing display quality.

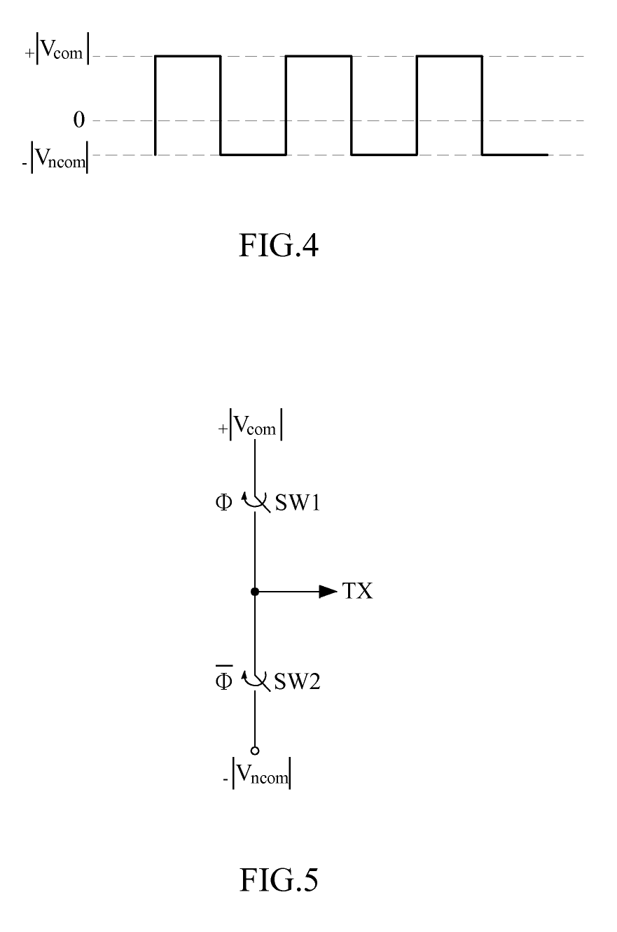

In the embodiment, the voltage swing of the TX driving signal is determined by taking into consideration the current leakage in the TFT unit cells. Specifically, as shown in FIG. 3, the voltage swing is the (positive) common voltage Vcom plus a negative voltage Vncom, where the negative voltage Vncom extends rightward in the figure. In other words, the voltage swing of the TX driving signal in the embodiment is a sum of magnitude (i.e., |Vcom|) of the common voltage Vcom associated with the common-voltage electrode substrate of the LCM and magnitude (i.e., |Vncom|) of the extended negative voltage Vncom. Therefore, the voltage swing of the TX driving signal is greater than the magnitude (i.e., |Vcom|) of the common voltage Vcom. As exemplified in FIG. 3, the TX driving signal ranges from +5V (corresponding to −15V of Vgs) to −5V (corresponding to −5V of Vgs). Accordingly, the voltage swing of the TX driving signal is the sum of 5V of |Vcom| and 5V of |Vncom|, therefore resulting in voltage swing of 10V. FIG. 4 shows an exemplary waveform of a TX driving signal that ranges from +|Vcom| to −|Vncom|. Although a square wave is exemplified, it is appreciated that other waveform, e.g., sinusoidal waveform, may be used instead.

The TX driving signal of the embodiment may be generated by using a variety of circuit design technique. For example, as schematically shown in FIG. 5, the TX driving signal may be obtained by alternately coupling to +|Vcom| and −|Vncom| via switches SW1 and SW2, respectively, which are controlled by switching control signals φ and inverted φ, respectively. It is appreciated that the +|Vcom| and/or −|Vncom| may be further derived, for example, by a pump circuit, from a voltage with less magnitude.

According to the embodiment described above, the voltage swing of the TX driving signal may be substantively raised without affecting current leakage in thin film transistor (TFT) unit cells in the display portion of the in-cell touch screen 100. Accordingly, the touch sensitivity of the in-cell touch screen 100 may be substantially enhanced while maintaining display quality of the in-cell touch screen 100.

Although specific embodiments have been illustrated and described, it will be appreciated by those skilled in the art that various modifications may be made without departing from the scope of the present invention, which is intended to be limited solely by the appended claims.

What is claimed is:

1. Apparatus of driving an in-cell touch screen, which comprises a receiver (RX) electrode substrate and a liquid crystal module (LCM) having a common-voltage electrode substrate, the apparatus comprising:
a transmitter (TX) driving unit configured to generate TX driving signals coupled to the common-voltage electrode substrate, RX detection signals being then induced on the RX electrode substrate that is coupled to and detected by an RX detection unit;
wherein a voltage swing of the TX driving signal is determined according to current leakage in thin film transistor (TFT) unit cells of the LCM.

2. The apparatus of claim 1, wherein the common-voltage electrode substrate is patterned with a plurality of TX electrode lines coupled to receive the TX driving signals.

3. The apparatus of claim 2, wherein the RX electrode substrate is patterned with a plurality of RX electrode lines coupled to the RX detection unit.

4. The apparatus of claim 1, wherein the voltage swing of the TX driving signal is a sum of magnitude of a common voltage associated with the common-voltage electrode substrate, and magnitude of an extended negative voltage.

5. The apparatus of claim 4, wherein the voltage swing of the TX driving signal is greater than the magnitude of the common voltage.

6. The apparatus of claim 4, wherein the TX driving signal ranges from a positive voltage to a negative voltage.

7. The apparatus of claim 4, wherein the TX driving unit comprises:
means for coupling to the common voltage;
means for coupling to the extended negative voltage;
a first switch, via which the common voltage is controllably outputted as the TX driving signal; and
a second switch, via which the extended negative voltage is controllably outputted as the TX driving signal;
wherein the first switch and the second switch are controlled by a switching control signal and an inverted switching control signal, respectively, such that the TX driving signal is obtained by alternately coupling to the common voltage and the extended negative voltage via the first switch and the second switch, respectively.

8. An in-cell touch screen, comprising:
a common-voltage electrode substrate associated with a liquid crystal module (LCM);
a transmitter (TX) driving unit configured to generate TX driving signals coupled to the common-voltage electrode substrate;
a receiver (RX) electrode substrate, on which RX detection signals being then induced due to the TX driving signals; and
an RX detection unit configured to detect the RX detection signals;
wherein a voltage swing of the TX driving signal is determined according to current leakage in thin film transistor (TFT) unit cells of the LCM.

9. The in-cell touch screen of claim 8, wherein the common-voltage electrode substrate is patterned with a plurality of TX electrode lines coupled to receive the TX driving signals.

10. The in-cell touch screen of claim 9, wherein the RX electrode substrate is patterned with a plurality of RX electrode lines coupled to the RX detection unit.

11. The in-cell touch screen of claim 8, wherein the voltage swing of the TX driving signal is a sum of magnitude of a common voltage associated with the common-voltage electrode substrate, and magnitude of an extended negative voltage.

12. The in-cell touch screen of claim 11, wherein the voltage swing of the TX driving signal is greater than the magnitude of the common voltage.

13. The in-cell touch screen of claim 11, wherein the TX driving signal ranges from a positive voltage to a negative voltage.

14. The in-cell touch screen of claim 11, wherein the TX driving unit comprises:
means for coupling to the common voltage;
means for coupling to the extended negative voltage;
a first switch, via which the common voltage is controllably outputted as the TX driving signal; and
a second switch, via which the extended negative voltage is controllably outputted as the TX driving signal;
wherein the first switch and the second switch are controlled by a switching control signal and an inverted switching control signal, respectively, such that the TX driving signal is obtained by alternately coupling to the common voltage and the extended negative voltage via the first switch and the second switch, respectively.
